(19) United States
(12) Patent Application Publication
(10) Pub. No.: US 2026/0183907 A1
(43) Pub. Date: Jul. 2, 2026

(54) Tool Holder Structure

(71) Applicant: David Tsai, Taichung City (TW)

(72) Inventor: David Tsai, Taichung City (TW)

(21) Appl. No.: 19/006,288

(22) Filed: Dec. 31, 2024

(51) Int. Cl. B25B 13/56

(52) U.S. Cl. CPC B25B 13/56

(57) ABSTRACT

A tool holder structure includes a first body, a second body, and multiple first tools. The first body is provided with multiple first receiving grooves, a first abutting face, multiple first slots, a second abutting face, a third abutting face, multiple second slots, a fourth abutting face, and a first slide guide. The second body is slidably mounted on the first body and provided with multiple second receiving grooves, a fifth abutting face, multiple third slots, a sixth abutting face, a seventh abutting face, multiple fourth slots, an eighth abutting face, a second slide guide, a first receiving recess, and a second receiving recess. Each of the first tools is received in each of the first receiving grooves and each of the second receiving grooves. Each of the first tools has two operation ends protruding from the first body and the second body.

### BACKGROUND OF THE INVENTION

### Field of the Invention

The present invention relates to a holder and, more particularly, to a tool holder structure for holding hand tools, such as hex wrenches or the like.

### Description of the Related Art

A conventional holder structure for a set of L-shaped wrenches was disclosed in the U.S. Pat. No. 2,776,744, and comprises a holder 10. The holder 10 includes a base means 11 and a clip cover panel 20 pivotally connected with the base means 11. The base means 11 is used to store wrenches 26, 27, 28, 29, 30, and 31. The clip cover panel 20 is used to store shorter ends 33, 34, 35, 36, 37, and 38.

However, the conventional holder structure has the following disadvantages.
1. The tools are stored in the base means 11 and the clip cover panel 20. The tools at the left side have a specification more than that of the tools at the right side. However, when the user wishes to take out the tools at the right side, it is necessary to rotate the tools at the left side so that the tools at the right side can be removed from the holder 10. For example, when the user wishes to take out the shorter end 38, it is necessary to rotate the shorter end 33, the shorter end 34, the shorter end 35, the shorter end 36, and the shorter end 37, thereby causing inconvenience to the user when needing to operate the tools.
2. As shown in FIG. 2, when the user wishes to move the tools upward and take out the tools, a larger contact area is defined between each of the tools and the base means 11 or the clip cover panel 20, so that the user has to apply a larger force to remove each of the tools from the base means 11 or the clip cover panel 20, thereby wasting the user's energy and time.

### BRIEF SUMMARY OF THE INVENTION

In accordance with the present invention, there is provided a tool holder structure comprising a first body, a second body, and multiple first tools. The first body is provided with a first face, a second face, a third face, a fourth face, multiple first receiving grooves, a first abutting face, multiple first slots, a second abutting face, a third abutting face, multiple second slots, a fourth abutting face, a first slide guide, a resting block, a first inclined face, a first abutting portion, and a first projection. The second body is slidably mounted on the first body. The second body is provided with a fifth face, a sixth face, a seventh face, and an eighth face. The second body is assembled with the first body, with the eighth face aligning with the second face. The second body is further provided with multiple second receiving grooves, a fifth abutting face, multiple third slots, a sixth abutting face, a seventh abutting face, multiple fourth slots, an eighth abutting face, a second slide guide, a first receiving recess, a second abutting portion, a second receiving recess, and a third abutting portion. Each of the first tools is received in each of the first receiving grooves and each of the second receiving grooves. Each of the first tools has two operation ends protruding from the first body respectively and protruding from the second body respectively.

According to the primary advantage of the present invention, the second body is assembled with the first body, with the eighth face aligning with the second face. The second slide guide of the second body may slidable on the first slide guide of the first body. The second slide guide slides into the first slide guide from a side thereof and is moved toward the resting block. After the second receiving recess passes the first projection, the second slide guide slides successively. When the second abutting portion presses the first inclined face, the resting block is contracted inward, so that the second receiving recess passes the resting block, and the second projection is received in the second receiving recess. At this time, the second abutting portion rests on the first abutting portion, and the third positioning portion is positioned on the first positioning portion, so that the second body is restricted by the second abutting portion and the first abutting portion and cannot be detached from the first body.

According to another advantage of the present invention, the second slide guide of the second body slides toward the resting block of the first body, so that the second body slides relative to the first body in parallel. The second receiving recess is detached from the second projection, and the third abutting portion rests on the first projection, so that the second body is restricted by the first projection and the third abutting portion and cannot be detached from the first body.

According to a further advantage of the present invention, the second body is allowed to slide relative to the first body through a distance by a limit between the second abutting portion and the first abutting portion, and by a limit between the third abutting portion and the first projection, so that the second body cannot be detached from the first body after the second body and the first body are assembled.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a tool holder structure in accordance with the preferred embodiment of the present invention.

FIG. 2 is a perspective view of a first body of the tool holder structure in accordance with the preferred embodiment of the present invention.

FIG. 3 is a perspective view of a second body of the tool holder structure in accordance with the preferred embodiment of the present invention.

FIG. 4 is a perspective view showing assembly of the first body and multiple first tools of the tool holder structure in accordance with the preferred embodiment of the present invention.

FIG. 5 is another perspective view showing assembly of the first body and the first tools of the tool holder structure in accordance with the preferred embodiment of the present invention.

FIG. 6 is a schematic operational view of the first body and the first tools as shown in FIG. 4.

FIG. 7 is a schematic operational view of the first body and the first tools as shown in FIG. 5.

FIG. 8 is a perspective assembly view of the tool holder structure in accordance with the preferred embodiment of the present invention.

FIG. 9 is a side view of the tool holder structure as shown in FIG. 8.

FIG. 10 is a front cross-sectional view of the tool holder structure taken along line A-A as shown in FIG. 9.

FIG. 11 is a locally enlarged view of the tool holder structure taken along circle B as shown in FIG. 10.

FIG. 12 is a perspective view showing a second operational state of the tool holder structure in accordance with the preferred embodiment of the present invention.

FIG. 13 is another perspective view showing the second operational state of the tool holder structure in accordance with the preferred embodiment of the present invention.

FIG. 14 is a side view of the tool holder structure as shown in FIG. 12.

FIG. 15 is a front cross-sectional view of the tool holder structure taken along line A-A as shown in FIG. 14.

FIG. 16 is a locally enlarged view of the tool holder structure taken along circle B as shown in FIG. 15.

FIG. 17 is a perspective view of a tool holder structure in accordance with the second preferred embodiment of the present invention.

### DETAILED DESCRIPTION OF THE INVENTION

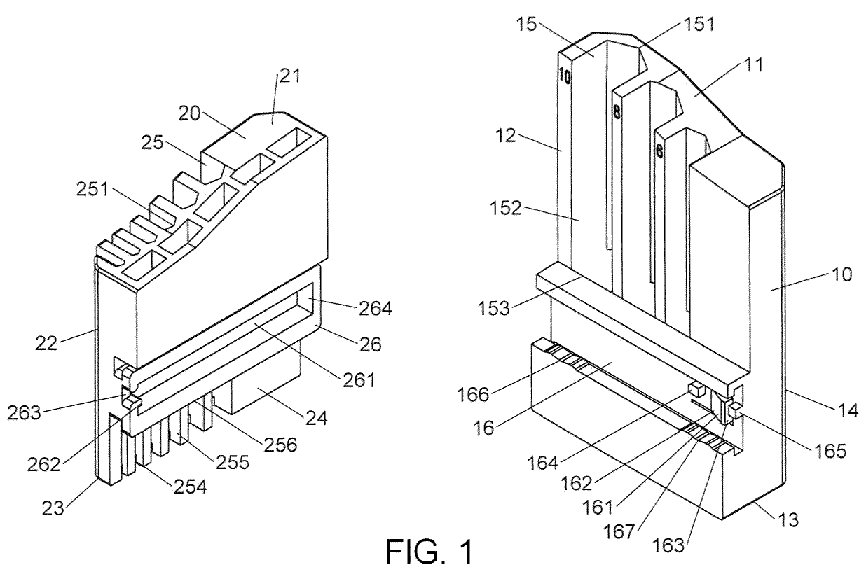

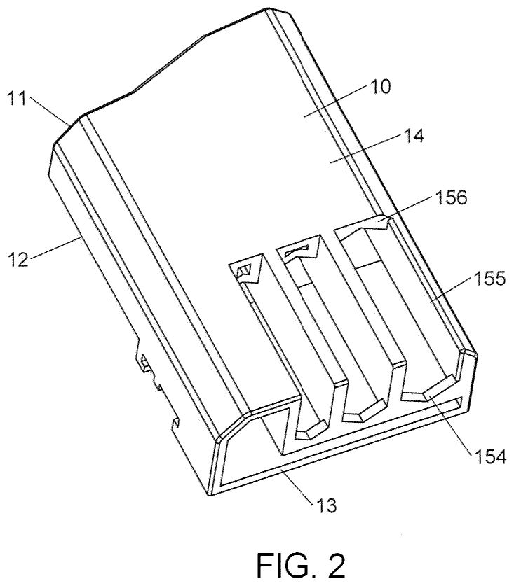

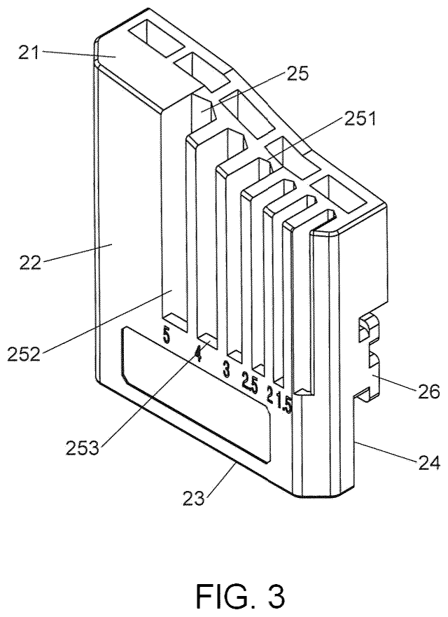

Referring to the drawings and initially to FIGS. 1-8, a tool holder structure in accordance with the preferred embodiment of the present invention comprises a first body 10, a second body 20, and multiple first tools 30.

The first body 10 is provided with a first face 11, a second face 12, a third face 13, and a fourth face 14. The first face 11 is provided with multiple first receiving grooves 15. Each of the first receiving grooves 15 is open in the first face 11 and the third face 13. Each of the first receiving grooves 15 extends through the first face 11 and the third face 13. Each of the first receiving grooves 15 is provided with a first abutting face 151 on a bottom of the first face 11. Preferably, the first abutting face 151 has two connected planes having an angle of one hundred and twenty degrees (120°). The first abutting face 151 has a hexagonal shape in cross-section to fit the first tools 30. The second face 12 is provided with multiple first slots 152. Each of the first slots 152 is connected to each of the first receiving grooves 15 and has an open shape. Each of the first slots 152 has an inner edge provided with a second abutting face 153 having a planar shape. Each of the first receiving grooves 15 is provided with a third abutting face 154 on a top of the third face 13. Preferably, the third abutting face 154 has two connected planes having an angle of one hundred and twenty degrees (120°). The third abutting face 154 has a hexagonal shape in cross-section to fit the first tools 30. The third abutting face 154 has a structure the same as that of the first abutting face 151. The fourth face 14 is provided with multiple second slots 155. Each of the second slots 155 is connected to each of the first receiving grooves 15 and has an open shape. Each of the first receiving grooves 15 is disposed between each of the first slots 152 and each of the second slots 155. Each of the first slots 152 and each of the second slots 155 are arranged symmetrically relative to each of the first receiving grooves 15. Each of the second slots 155 has an inner edge provided with a fourth abutting face 156 having a planar shape. The fourth abutting face 156 has a structure the same as that of the second abutting face 153. The fourth abutting face 156 and the second abutting face 153 are disposed at the same plane. The second face 12 is provided with a first slide guide (or rail or track) 16 adjacent to the third face 13. The first slide guide 16 is provided with a resting block 161 having an elastic feature. The resting block 161 is provided with a first inclined face 162 and a first abutting portion 163. Preferably, the first inclined face 162 is a ramp or slope. The first abutting portion 163 is located at an end of the resting block 161. Preferably, the first abutting portion 163 has a planar shape. The resting block 161 has a first side provided with a first projection 164 distant from the first abutting portion 163. The resting block 161 has a second side provided with a second projection 165 adjacent to the first abutting portion 163. The resting block 161 is disposed between the first projection 164 and the second projection 165. The first slide guide 16 has a bottom provided with a first positioning portion 166 and a second positioning portion 167. The first positioning portion 166 is distant from the second positioning portion 167. The second positioning portion 167 is located under the resting block 161. Each of the first positioning portion 166 and the second positioning portion 167 has a convex corrugated shape.

The second body 20 is slidably mounted on the first body 10. The second body 20 is provided with a fifth face 21, a sixth face 22, a seventh face 23, and an eighth face 24. The second body 20 is assembled with the first body 10, with the eighth face 24 aligning with the second face 12. The fifth face 21 is provided with multiple second receiving grooves 25. Each of the second receiving grooves 25 is open in the fifth face 21 and the seventh face 23. Each of the second receiving grooves 25 extends through the fifth face 21 and the seventh face 23. Each of the second receiving grooves 25 is provided with a fifth abutting face 251 on a bottom of the fifth face 21. Preferably, the fifth abutting face 251 has two connected planes having an angle of one hundred and twenty degrees (120°). The fifth abutting face 251 has a hexagonal shape in cross-section to fit the first tools 30. The sixth face 22 is provided with multiple third slots 252. Each of the third slots 252 is connected to each of the second receiving grooves 25 and has an open shape. Each of the third slots 252 has an inner edge provided with a sixth abutting face 253 having a planar shape. Each of the second receiving grooves 25 is provided with a seventh abutting face 254 on a top of the seventh face 23. Preferably, the seventh abutting face 254 has two connected planes having an angle of one hundred and twenty degrees (120°). The seventh abutting face 254 has a hexagonal shape in cross-section to fit the first tools 30. The seventh abutting face 254 has a structure the same as that of the fifth abutting face 251. The eighth face 24 is provided with multiple fourth slots 255. Each of the fourth slots 255 is connected to each of the second receiving grooves 25 and has an open shape. Each of the second receiving grooves 25 is disposed between each of the third slots 252 and each of the fourth slots 255. Each of the third slots 252 and each of the fourth slots 255 are arranged symmetrically relative to each of the second receiving grooves 25. Each of the fourth slots 255 has an inner edge provided with an eighth abutting face 256 having a planar shape. The eighth abutting face 256 has a structure the same as that of the sixth abutting face 253. The eighth face 24 is provided with a second slide guide (or rail or track) 26 adjacent to the seventh face 23. The second slide guide 26 aligns with the first slide guide 16. The second slide guide 26 is slidably mounted on the first slide guide 16 so that the second body 20 is slidably mounted on the first body 10. The second slide guide 26 has an interior provided with a first receiving recess 261 for receiving the resting block 161 and the first projection 164 of the first body 10. Preferably, the first receiving recess 261 is a cavity. The first receiving recess 261 is slidable on the resting block 161 and the first projection 164. The first receiving recess 261 has an open first side provided with a second abutting portion 262 abutting the first abutting portion 163, so that the second body 20 is slidably mounted on and cannot be detached from the first body 10. The open first side of the first receiving recess 261 is provided with a second receiving recess 263 connected to the first receiving recess 261. The second receiving recess 263 is disposed at a side of the second abutting portion 262. The second receiving recess 263 allows passage of the first projection 164 and accommodates the second projection 165. The first receiving recess 261 has a closed second side provided with a third abutting portion 264 that is moved to rest on the first projection 164 when the second body 20 is slidable relative to the first body 10, so that the second body 20 cannot be detached from the first body 10. Thus, the second body 20 is allowed to slide relative to the first body 10 through a distance by a limit between the second abutting portion 262 and the first abutting portion 163, and by a limit between the third abutting portion 264 and the first projection 164. The second slide guide 26 has a bottom provided with a third positioning portion 265 (see FIG. 10) that is slidable between the first positioning portion 166 and the second positioning portion 167. The third positioning portion 265 is positioned on the first positioning portion 166 as shown in FIG. 10 or the second positioning portion 167 as shown in FIG. 11, so that the second body 20 has two positioned positions relative to the first body 10.

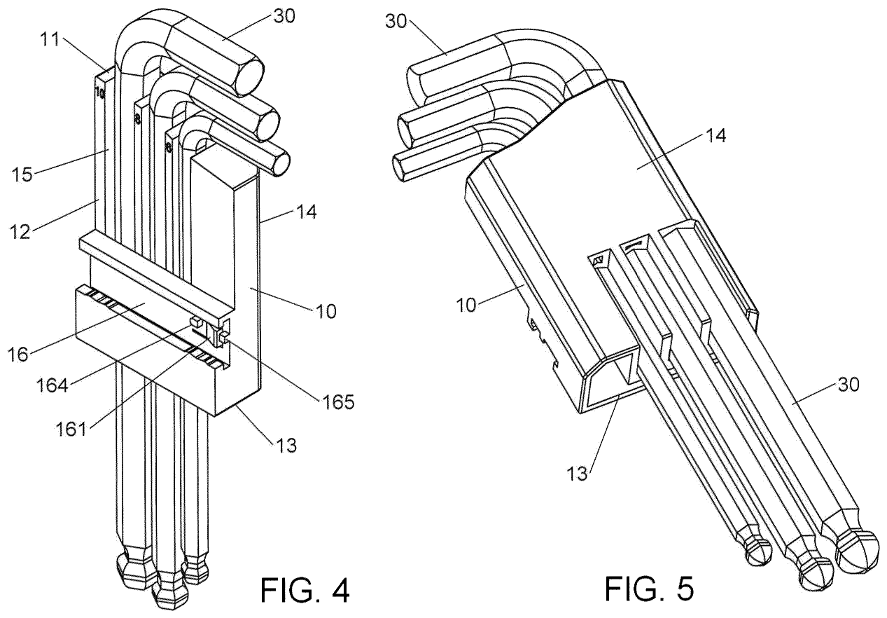

Each of the first tools 30 is a hand tool or hex wrench of different specifications and sizes. Each of the first tools 30 is received in each of the first receiving grooves 15 as shown in FIGS. 4 and 5. Each of the first tools 30 has a hexagonal shank mounted on the first abutting face 151 and the third abutting face 154. Each of the first tools 30 has two operation (or drive) ends protruding from the first body 10 respectively.

The second receiving grooves 25 of the second body 20 has a structure the same as that of the first receiving grooves 15 of the first body 10. The fifth abutting face 251 has a structure the same as that of the first abutting face 151. The seventh abutting face 254 has a structure the same as that of the third abutting face 154. The sixth abutting face 253 has a structure the same as that of the second abutting face 153. The eighth abutting face 256 has a structure the same as that of the fourth abutting face 156. Each of the first tools 30 is received in each of the second receiving grooves 25. The hexagonal shank of each of the first tools 30 is mounted on the fifth abutting face 251 and the seventh abutting face 254, and the two operation ends of each of the first tools 30 protrudes from the second body 20 respectively.

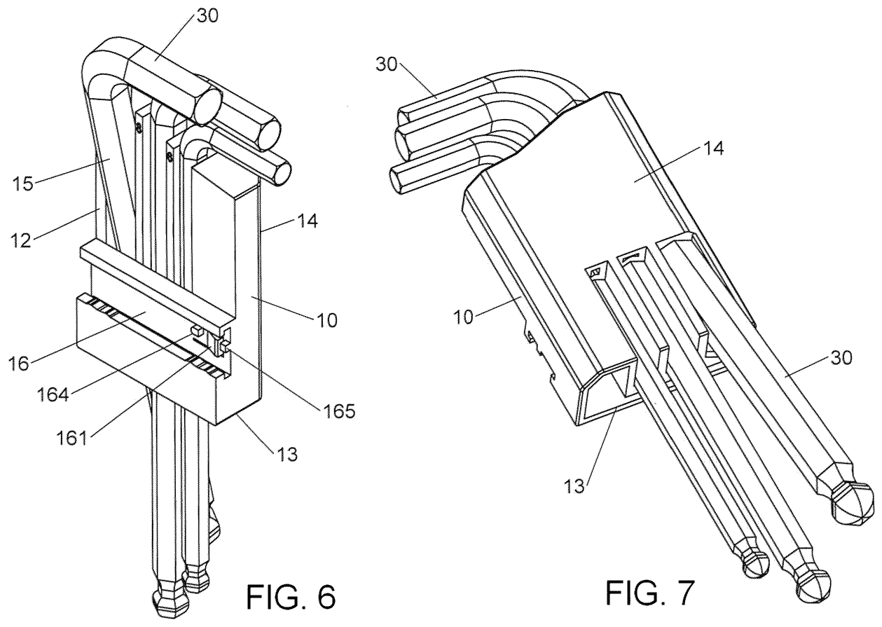

Referring to FIGS. 6 and 7 with reference to FIGS. 1-5, each of the first receiving grooves 15 is open in the first face 11 and the third face 13. Each of the first slots 152 is open and connected to each of the first receiving grooves 15. Each of the second slots 155 is open and connected to each of the first receiving grooves 15. Thus, each of the first tools 30 may be inserted into or removed from each of the first receiving grooves 15 in an inclined manner. The inclined angle of each of the first tools 30 relative to the first body 10 is equal to or less than forty-five degrees (45°). Thus, the friction force between each of the first tools 30 and each of the first receiving grooves 15 has the minimum value, so that the user can remove the first tools 30 from the first body 10 in an energy-saving manner. Similarly, each of the second receiving grooves 25 is open in the fifth face 21 and the seventh face 23. Each of the third slots 252 is open and connected to each of the second receiving grooves 25. Each of the fourth slots 255 is open and connected to each of the second receiving grooves 25. Thus, each of the first tools 30 may be inserted into or removed from each of the second receiving grooves 25 in an inclined manner. The inclined angle of each of the first tools 30 relative to the second body 20 is equal to or less than forty-five degrees (45°). Thus, the friction force between each of the first tools 30 and each of the second receiving grooves 25 has the minimum value, so that the user can remove the first tools 30 from the second body 20 in an energy-saving manner.

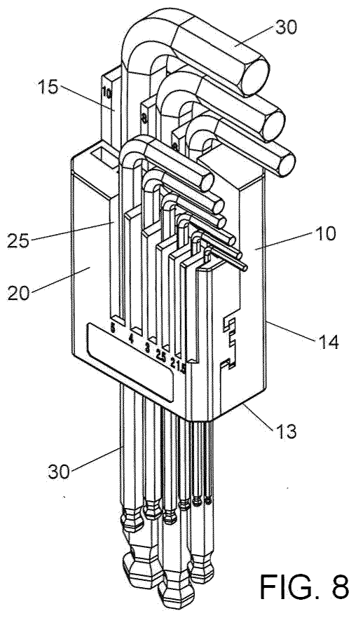

Referring to FIG. 8 with reference to FIGS. 1-7, the first body 10 and the second body 20 are assembled, and the first tools 30 are mounted on the first body 10 and the second body 20. The second slide guide 26 of the second body 20 is slidably mounted on the first slide guide 16 of the first body 10. Each of the first tools 30 is received in each of the first receiving grooves 15 of the first body 10 and each of the second receiving grooves 25 of the second body 20. At this time, each of the first tools 30 received in each of the first receiving grooves 15 is restricted by the second body 20 and cannot be removed from the first body 10 in an inclined manner, so that the first tools 30 are directly taken out from the first face 11. Similarly, each of the first tools 30 received in each of the second receiving grooves 25 is restricted by the first body 10 and cannot be removed from the second body 20 in an inclined manner, so that the first tools 30 are directly taken out from the fifth face 21.

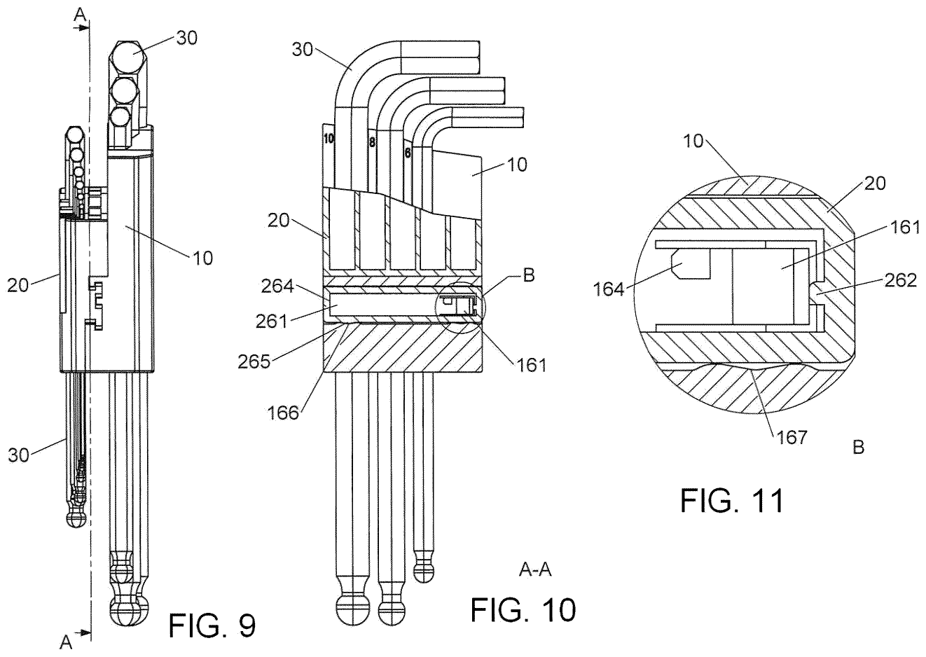

Referring to FIGS. 9-11 with reference to FIGS. 1-8, the second slide guide 26 of the second body 20 is slidably mounted on the first slide guide 16 of the first body 10. The second slide guide 26 slides into the first slide guide 16 from a side thereof and is moved toward the resting block 161. After the second receiving recess 263 passes the first projection 164, the second slide guide 26 slides successively. When the second abutting portion 262 presses the first inclined face 162, the resting block 161 is contracted inward, so that the second abutting portion 262 and the second receiving recess 263 pass the resting block 161, and the second projection 165 is received in the second receiving recess 263. At this time, the second abutting portion 262 rests on the first abutting portion 163 so that the second body 20 is restricted by the second abutting portion 262 and the first abutting portion 163 and cannot be detached from the first body 10, the third positioning portion 265 is positioned on the first positioning portion 166, and the tool holder structure is disposed at a first assembled state.

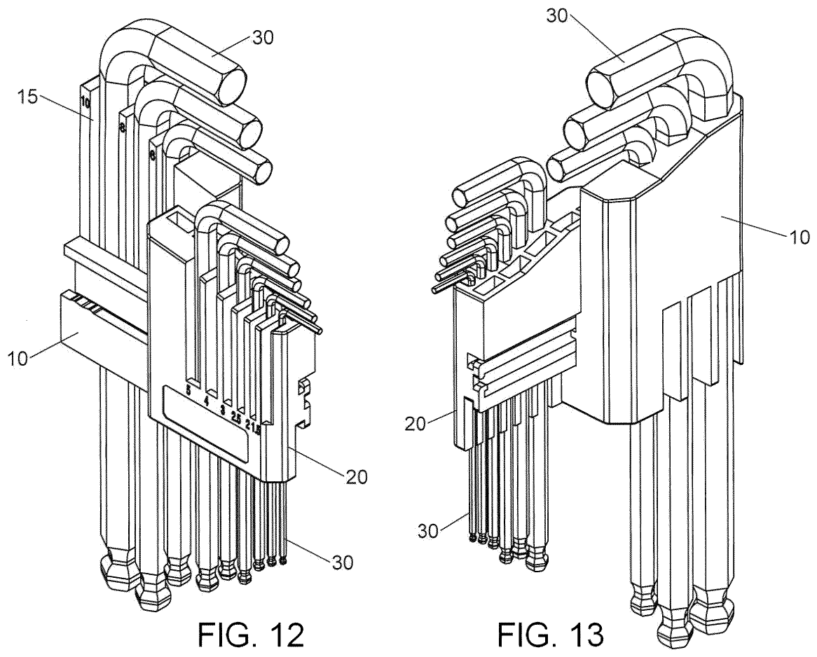

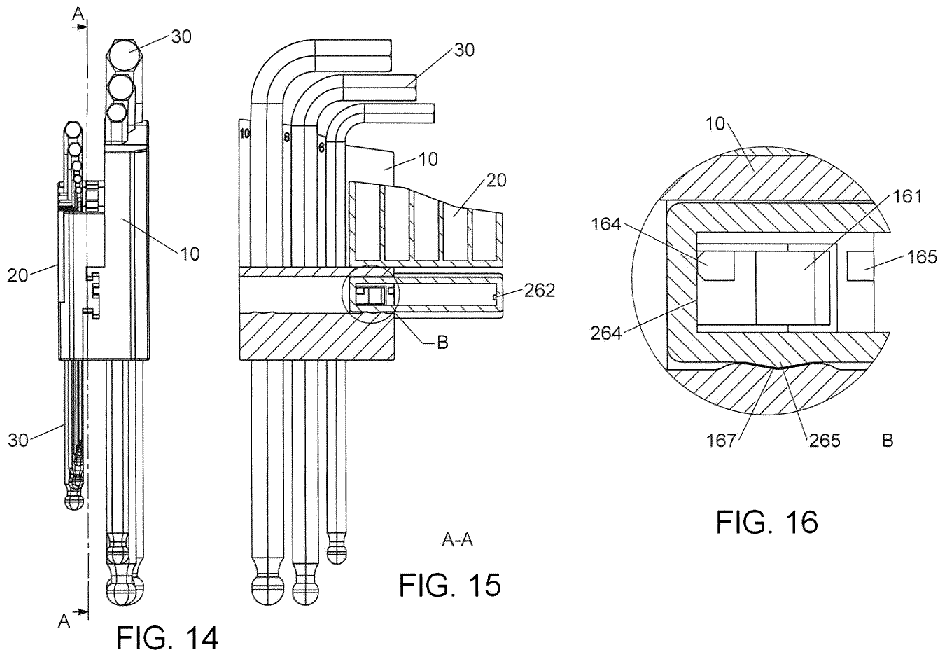

Referring to FIGS. 12-16 with reference to FIGS. 1-11, the second slide guide 26 of the second body 20 slides toward the resting block 161 of the first body 10, so that the second body 20 slides relative to the first body 10 in parallel. The second receiving recess 263 is detached from the second projection 165, and the third abutting portion 264 rests on the first projection 164, so that the second body 20 is restricted by the first projection 164 and the third abutting portion 264 and cannot be detached from the first body 10, the third positioning portion 265 is positioned on the second positioning portion 167, and the tool holder structure is disposed at a second assembled state.

At this time, each of the first tools 30 received in each of the first receiving grooves 15 is not restricted by the second body 20 and can be removed from the first body 10 in an inclined manner, and each of the first tools 30 received in each of the second receiving grooves 25 is not restricted by the first body 10 and can be removed from the second body 20 in an inclined manner, so that the user can remove the first tools 30 from the first body 10 or the second body 20 in an energy-saving manner.

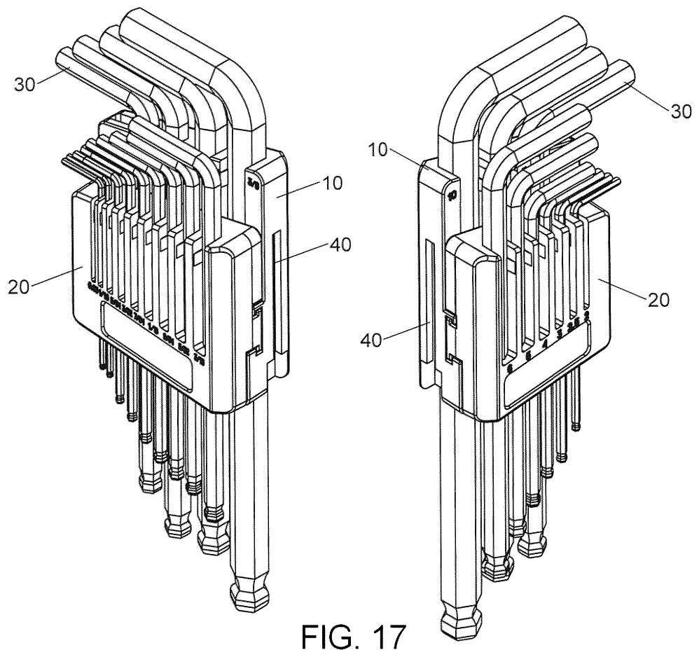

Referring to FIG. 17, the first body 10 has a side provided with a third slide guide (or rail or track) 40. The tool holder structure of the present invention further comprises a third body having two sides each provided with a fourth slide guide (or rail or track) slidably mounted on the third slide guide 40. Thus, the two sides of the third body are assembled with two tool holder structures, so that the third body is assembled between the two tool holder structures.

In accordance with another preferred embodiment of the present invention, the second projection 165 is undefined.

In accordance with another preferred embodiment of the present invention, the first positioning portion 166 and the second positioning portion 167 of the first body 10 are undefined, and the third positioning portion 265 of the second body 20 is undefined, so that there is no positioning effect when the second slide guide 26 of the second body 20 slides on the first slide guide 16 of the first body 10.

Accordingly, the tool holder structure of the present invention has the following advantages.
1. The second body 20 is assembled with the first body 10, with the eighth face 24 aligning with the second face 12. The second slide guide 26 of the second body 20 may slidable on the first slide guide 16 of the first body 10. The second slide guide 26 slides into the first slide guide 16 from a side thereof and is moved toward the resting block 161. After the second receiving recess 263 passes the first projection 164, the second slide guide 26 slides successively. When the second abutting portion 262 presses the first inclined face 162, the resting block 161 is contracted inward, so that the second receiving recess 263 passes the resting block 161, and the second projection 165 is received in the second receiving recess 263. At this time, the second abutting portion 262 rests on the first abutting portion 163, and the third positioning portion 265 is positioned on the first positioning portion 166, so that the second body 20 is restricted by the second abutting portion 262 and the first abutting portion 163 and cannot be detached from the first body 10.
2. The second slide guide 26 of the second body 20 slides toward the resting block 161 of the first body 10, so that the second body 20 slides relative to the first body 10 in parallel. The second receiving recess 263 is detached from the second projection 165, and the third abutting portion 264 rests on the first projection 164, so that the second body 20 is restricted by the first projection 164 and the third abutting portion 264 and cannot be detached from the first body 10.
3. The second body 20 is allowed to slide relative to the first body 10 through a distance by a limit between the second abutting portion 262 and the first abutting portion 163, and by a limit between the third abutting portion 264 and the first projection 164, so that the second body 20 cannot be detached from the first body 10 after the second body 20 and the first body 10 are assembled.
4. Referring to FIG. 8, when the tool holder structure is disposed at the first assembled state, each of the first tools 30 received in each of the first receiving grooves 15 is restricted by the second body 20 and cannot be removed from the first body 10 in an inclined manner, so that the first tools 30 are directly taken out from the first face 11. Similarly, each of the first tools 30 received in each of the second receiving grooves 25 is restricted by the first body 10 and cannot be removed from the second body 20 in an inclined manner, so that the first tools 30 are directly taken out from the fifth face 21.
5. When the tool holder structure is disposed at the second assembled state, each of the first tools 30 received in each of the first receiving grooves 15 is not restricted by the second body 20 and can be removed from the first body 10 in an inclined manner, and each of the first tools 30 received in each of the second receiving grooves 25 is not restricted by the first body 10 and can be removed from the second body 20 in an inclined manner, so that the user can remove the first tools 30 from the first body 10 or the second body 20 in an energy-saving manner.
6. Each of the first slots 152 is open and connected to each of the first receiving grooves 15. Each of the second slots 155 is open and connected to each of the first receiving grooves 15. Thus, each of the first tools 30 may be inserted into or removed from each of the first receiving grooves 15 in an inclined manner, so that the user can remove the first tools 30 from the first body 10 in an energy-saving manner. Similarly, each of the third slots 252 is open and connected to each of the second receiving grooves 25. Each of the fourth slots 255 is open and connected to each of the second receiving grooves 25. Thus, each of the first tools 30 may be inserted into or removed from each of the second receiving grooves 25 in an inclined manner, so that the user can remove the first tools 30 from the second body 20 in an energy-saving manner.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A tool holder structure comprising:
a first body, a second body, and multiple first tools:
wherein:
the first body is provided with a first face, a second face, a third face, and a fourth face;
the first face is provided with multiple first receiving grooves;
each of the first receiving grooves is open in the first face and the third face;
each of the first receiving grooves extends through the first face and the third face;
each of the first receiving grooves is provided with a first abutting face on a bottom of the first face;
the second face is provided with multiple first slots;
each of the first slots is connected to each of the first receiving grooves and has an open shape;
each of the first slots has an inner edge provided with a second abutting face having a planar shape;
each of the first receiving grooves is provided with a third abutting face on a top of the third face;
the fourth face is provided with multiple second slots;
each of the second slots is connected to each of the first receiving grooves and has an open shape;
each of the first receiving grooves is disposed between each of the first slots and each of the second slots;
each of the first slots and each of the second slots are arranged symmetrically relative to each of the first receiving grooves;
each of the second slots has an inner edge provided with a fourth abutting face having a planar shape;
the fourth abutting face has a structure the same as that of the second abutting face;
the fourth abutting face and the second abutting face are disposed at the same plane;
the second face is provided with a first slide guide adjacent to the third face;
the first slide guide is provided with a resting block having an elastic feature;
the resting block is provided with a first inclined face and a first abutting portion;
the first abutting portion is located at an end of the resting block;
the resting block has a first side provided with a first projection distant from the first abutting portion;
the resting block has a second side provided with a second projection adjacent to the first abutting portion;
the resting block is disposed between the first projection and the second projection;
the first slide guide has a bottom provided with a first positioning portion and a second positioning portion;
the first positioning portion is distant from the second positioning portion;
the second positioning portion is located under the resting block;
each of the first positioning portion and the second positioning portion has a convex corrugated shape;
the second body is slidably mounted on the first body;
the second body is provided with a fifth face, a sixth face, a seventh face, and an eighth face;
the second body is assembled with the first body, with the eighth face aligning with the second face;
the fifth face is provided with multiple second receiving grooves;
each of the second receiving grooves is open in the fifth face and the seventh face;
each of the second receiving grooves extends through the fifth face and the seventh face;
each of the second receiving grooves is provided with a fifth abutting face on a bottom of the fifth face;
the sixth face is provided with multiple third slots;
each of the third slots is connected to each of the second receiving grooves and has an open shape;
each of the third slots has an inner edge provided with a sixth abutting face having a planar shape;
each of the second receiving grooves is provided with a seventh abutting face on a top of the seventh face;
the eighth face is provided with multiple fourth slots;
each of the fourth slots is connected to each of the second receiving grooves and has an open shape;
each of the second receiving grooves is disposed between each of the third slots and each of the fourth slots;
each of the third slots and each of the fourth slots are arranged symmetrically relative to each of the second receiving grooves;
each of the fourth slots has an inner edge provided with an eighth abutting face having a planar shape;
the eighth abutting face has a structure the same as that of the sixth abutting face;
the eighth face is provided with a second slide guide adjacent to the seventh face;
the second slide guide aligns with the first slide guide;
the second slide guide is slidably mounted on the first slide guide so that the second body is slidably mounted on the first body;
the second slide guide has an interior provided with a first receiving recess for receiving the resting block and the first projection of the first body;
the first receiving recess is slidable on the resting block and the first projection;
the first receiving recess has an open first side provided with a second abutting portion abutting the first abutting portion, so that the second body is slidably mounted on and cannot be detached from the first body;
the open first side of the first receiving recess is provided with a second receiving recess connected to the first receiving recess;
the second receiving recess is disposed at a side of the second abutting portion;
the second receiving recess allows passage of the first projection and accommodates the second projection;
the first receiving recess has a closed second side provided with a third abutting portion that is moved to rest on the first projection when the second body is slidable relative to the first body, so that the second body cannot be detached from the first body;
the second body is allowed to slide relative to the first body through a distance by a limit between the second abutting portion and the first abutting portion, and by a limit between the third abutting portion and the first projection;
the second slide guide has a bottom provided with a third positioning portion that is slidable between the first positioning portion and the second positioning portion;
the third positioning portion is positioned on the first positioning portion or the second positioning portion, so that the second body has two positioned positions relative to the first body;
each of the first tools is hex wrench of different specifications;
each of the first tools is received in each of the first receiving grooves;
each of the first tools has two operation ends protruding from the first body respectively;
the second receiving grooves of the second body has a structure the same as that of the first receiving grooves of the first body;
the fifth abutting face has a structure the same as that of the first abutting face;
the seventh abutting face has a structure the same as that of the third abutting face;
the sixth abutting face has a structure the same as that of the second abutting face;
the eighth abutting face has a structure the same as that of the fourth abutting face;
each of the first tools is received in each of the second receiving grooves; and
the two operation ends of each of the first tools protrudes from the second body respectively.

2. The tool holder structure as claimed in claim 1, wherein:
the first abutting face has two connected planes having an angle of one hundred and twenty degrees; and
the first abutting face has a hexagonal shape in cross-section to fit the first tools.

3. The tool holder structure as claimed in claim 2, wherein:
the third abutting face has two connected planes having an angle of one hundred and twenty degrees;
the third abutting face has a hexagonal shape in cross-section to fit the first tools; and
the third abutting face has a structure the same as that of the first abutting face.

4. The tool holder structure as claimed in claim 1, wherein:
the fifth abutting face has two connected planes having an angle of one hundred and twenty degrees; and
the fifth abutting face has a hexagonal shape in cross-section to fit the first tools.

5. The tool holder structure as claimed in claim 4, wherein:
the seventh abutting face has two connected planes having an angle of one hundred and twenty degrees;
the seventh abutting face has a hexagonal shape in cross-section to fit the first tools; and
the seventh abutting face has a structure the same as that of the fifth abutting face.

6. The tool holder structure as claimed in claim 1, wherein:
the second slide guide of the second body is slidably mounted on the first slide guide of the first body;
the second slide guide slides into the first slide guide from a side thereof and is moved toward the resting block;
after the second receiving recess passes the first projection, the second slide guide slides successively;
when the second abutting portion presses the first inclined face, the resting block is contracted inward, so that the second abutting portion and the second receiving recess pass the resting block, and the second projection is received in the second receiving recess;
the second abutting portion rests on the first abutting portion so that the second body is restricted by the second abutting portion and the first abutting portion and cannot be detached from the first body, and the tool holder structure is disposed at a first assembled state.

7. The tool holder structure as claimed in claim 1, wherein:
the second slide guide of the second body slides toward the resting block of the first body, so that the second body slides relative to the first body in parallel;
the second receiving recess is detached from the second projection, and the third abutting portion rests on the first projection, so that the second body is restricted by the first projection and the third abutting portion and cannot be detached from the first body, and the tool holder structure is disposed at a second assembled state.

8. The tool holder structure as claimed in claim 1, wherein:
the first body has a side provided with a third slide guide;
the tool holder structure further comprises a third body having two sides each provided with a fourth slide guide slidably mounted on the third slide guide; and
the two sides of the third body are assembled with two tool holder structures, so that the third body is assembled between the two tool holder structures.
